(19) United States
(12) Patent Application Publication
(10) Pub. No.: US 2015/0025710 A1
(43) Pub. Date: Jan. 22, 2015

(54) METHOD AND APPARATUS FOR RETURNING MOVING BODY

(71) Applicant: Electronics and Telecommunications Research Institute, Daejeon (KR)

(72) Inventor: Seung Hwan PARK, Daejeon (KR)

(73) Assignee: Electronics and Telecommunications Research Institute, Daejeon (KR)

(21) Appl. No.: 14/168,533

(22) Filed: Jan. 30, 2014

(30) Foreign Application Priority Data
Jul. 17, 2013 (KR) 10-2013-0084049

(51) Int. Cl. G05D 1/02; G05D 1/00

(52) U.S. Cl. CPC G05D 1/028; G05D 1/0022
USPC 701/2

(57) ABSTRACT

A method for returning a moving body in a moving body returning apparatus includes detecting a remote control signal from a remote controlling apparatus; acquiring data corresponding to a reference direction to return the moving body when the control relevant to the remote control signal is not feasible; and carrying out a returning control to return the moving body to an initial starting location using the data relevant to the reference direction. Further, the method includes stopping the returning control and activating the remote control signal of the remote controlling apparatus when the moving body arrives at the initial starting location.

### CROSS-REFERENCE TO RELATED APPLICATION(S)

The present invention claims priority of Korean Patent Application No. 10-2013-0084049, filed on Jul. 17, 2013, which is incorporated herein by reference.

### FIELD OF THE INVENTION

The present invention relates to a method and apparatus for returning a moving body, and more specifically, to a method and apparatus for returning a moving body to its initial location from a hazard area when the moving body cannot be controlled.

### BACKGROUND OF THE INVENTION

In recent years, there has been proposed a method to deploy a moving body such as a mobile robot in an area where people do not access directly because of a lot of hazardous factors such as radioactive area and remotely control the moving body to accomplish the intended task.

After that, a method of returning the moving body to its origin point is performed by a method using image information. In connection with the method of returning the moving body, a prior art discloses a method to control the moving body to return to the origin point by using the infrared image information of an infrared module inputted from a camera module.

However, in the provision of the method to return the moving body, the aforementioned prior art does not disclose how to return the moving body to an initial starting point when the communication between the moving body and a remote control device is disconnected. Further, the prior art is silent to disclose any configuration in which the moving body is controlled to independently move in the direction of the initial starting location when it is located in the hazardous area but personnel cannot access the hazardous area in order to retrieve it.

### SUMMARY OF THE INVENTION

In view of the above, the present invention provides a method and apparatus for returning a moving body that are capable of controlling the moving body to return its initial starting location by photographing a portion of a cable of the moving body and setting the direction for which the portion of the cable is headed as a moving direction to move the moving body, in the case where the moving body is connected to a remote controlling apparatus by wire, and that are capable of controlling the moving body to return its initial starting location by sequentially storing IDs of APs to which the moving body accessed while it is moving and detecting an RSSI of the AP to which the moving body accesses at current location, in the case where the moving body is wirelessly connected to the remote controlling apparatus. However, the technical subjects of the embodiment of the present invention are not limited to the aforementioned subjects, and there may be other technical subjects.

In accordance with a first aspect of the present invention, there is provided a method for returning a moving body in a moving body returning apparatus. The method includes detecting a remote control signal from a remote controlling apparatus; acquiring data corresponding to a reference direction to return the moving body when the control relevant to the remote control signal is not feasible; carrying out a returning control to return the moving body to an initial starting location using the data relevant to the reference direction; and stopping the returning control and activating the remote control signal of the remote controlling apparatus when the moving body arrives at the initial starting location.

In accordance with a second aspect of the present invention, there is provided an apparatus for returning a moving body. The apparatus includes a detection unit configured to detect a remote control signal from a remote controlling apparatus; an acquisition unit configured to acquire data relevant to a reference direction to return the moving body when the control relevant to the remote control signal is not feasible; an execution unit configured to carry out a returning control to return the moving body to an initial starting location using the data relevant to the reference direction; and an activation unit configured to stop the returning control and activating the remote control signal of the remote controlling apparatus when the moving body arrives at the initial starting location.

In accordance with any one of solutions to the subject described above, it is possible to implement a method to return the moving body to its origin point by actively utilizing a moving body's own power even if the moving body is placed in a situation where it cannot be controlled, thereby prevent safety accidents in advance since personnel need not to put in the danger zone.

### BRIEF DESCRIPTION OF THE DRAWINGS

The above and other objects and features of the present invention will become apparent from the following description of the embodiments given in conjunction with the accompanying drawings, in which:

FIG. 1 shows a configuration diagram of a system for returning a moving body in accordance with an embodiment of the present invention;

FIG. 2 is a block diagram of the moving body returning apparatus shown in FIG. 1;

FIG. 3A is an exemplary diagram illustrating an embodiment wherein the moving body returning apparatus shown in FIG. 1 controls a moving body wirelessly;

FIG. 3B is an exemplary diagram illustrating an embodiment wherein the moving body returning apparatus shown in FIG. 1 controls a moving body by wire;

FIG. 4 is a sequential diagram illustrating a process of transmitting and receiving data between the respective components of the system for returning a moving body shown in FIG. 1 in accordance with an embodiment of the present invention;

FIG. 5 is a sequential diagram illustrating a process of transmitting and receiving data between the respective components of the system for returning a moving body shown in FIG. 1 in accordance with another embodiment of the present invention; and

FIG. 6 is a flow diagram explaining a method for returning a moving body in accordance with an embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art.

Throughout the specification and the claims, when an element is described as being “connected” to another element, this implies that the elements may be directly connected together or the elements may be connected through one or more intervening elements. Furthermore, when an element is described as “including” one or more elements, this does not exclude additional, unspecified elements, nor does it preclude the presence or addition of one or more other features, integers, steps, operations, elements, components and/or groups thereof.

Hereinafter, the embodiments of the present invention will be described in detail with reference to the accompanying drawings.

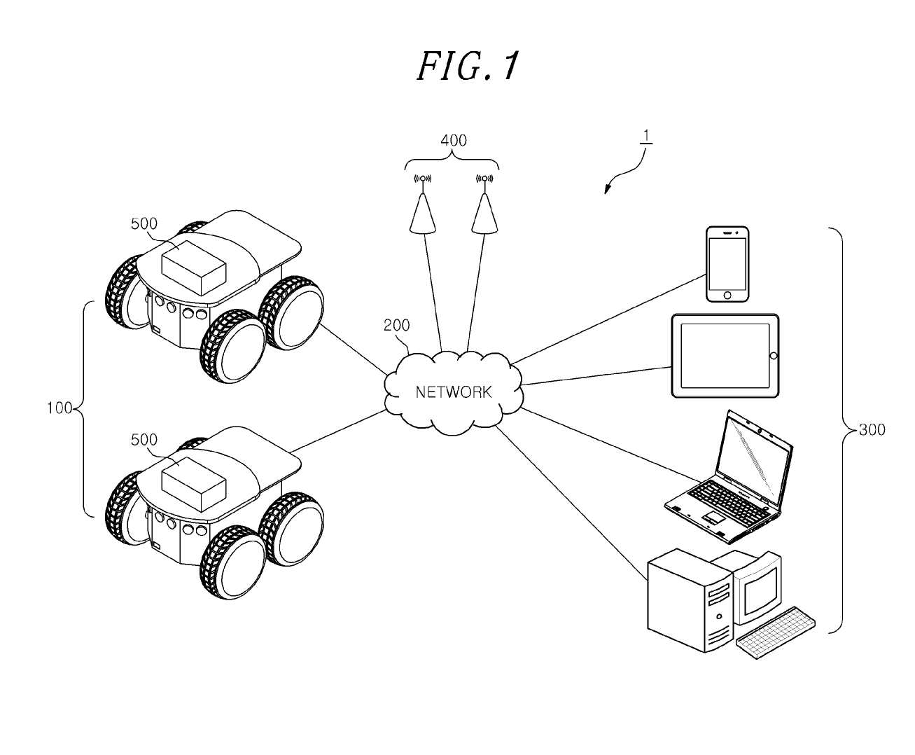

FIG. 1 shows a configuration diagram of a system for returning a moving body in accordance with an embodiment of the present invention. Referring to FIG. 1, a system 1 for returning a moving body includes a moving body returning apparatus 500, a moving body 100 including the moving body returning apparatus 500, a remote controlling apparatus 300, and one or more APs (Access Points) 400. However, the system 1 for returning the moving body 100 is merely an example and the present invention is therefore not construed to be limited to that illustrated in FIG. 1.

The respective components of FIG. 1 are typically connected through a wired or wireless network 200. For example, as shown in FIG. 1, the moving body returning apparatus 500 is connected to the remote controlling apparatus 300 are via the network 200, and the moving body returning apparatus 500 and the APs 400 are connected via the network 200. It is noted that the moving body returning apparatus 500, the remote controlling apparatus 300 and the APs 400 are not construed to be limited to those shown in FIG. 1.

The moving body returning apparatus 500 may be mounted in the moving body 100 and may be implemented by e.g., a computer, and the moving body 100 may be a mobile robot that is controlled by wire or wirelessly. Further, the moving body returning apparatus 500 may be alternatively implemented by an embedded board only for returning of the moving body 100 and may be provided separately from the moving body 100. The moving body 100 may be a self-independent mobile robot that has sensors corresponding to the eye and self-decision-making ability like as a computer or a robot that receives a control signal transmitted from a remote location and is controlled by the control signal. In the case where the moving body 100 uses a wired communication network, the moving body 100 has a wired connection with the remote controlling apparatus 300. In the case where the moving body 100 uses a wireless communication network, the moving body 100 has a wireless connection with the remote controlling apparatus 300.

The remote controlling apparatus 300 may be an apparatus to transmit a remote control signal to the moving body returning apparatus 500. In this case, the remote controlling apparatus 300 and the moving body 100 may be wired or wirelessly connected with each other. Here, the remote controlling apparatus 300 may be implemented by a computing device capable of accessing a server or terminal at a remote location through the network 200. For example, the computing device may include a notebook computer, desktop computer, laptop computer or the like having a web browser mounted therein. Also, the remote controlling apparatus 300 may be implemented by a handheld-based wireless communication device that ensures portability and mobility, for example, which may include any kind of handheld-based wireless communication device such as a handset for PCS (Personal Communication System), GSM (Global System for Mobile communications), PDC (Personal Digital Cellular), PHS (Personal Handy phone System), PDA (Personal Digital Assistant), IMT (International Mobile Telecommunication)-2000, CDMA (Code Division Multiple Access)-2000, W-CDMA (W-Code Division Multiple Access), or Wibro (Wireless Broadband Internet), or smartphone, smart pad, Tablet PC, or the like.

A moving body returning method of the embodiment of the present invention will be described by way of example as follows.

In recent years, there exists a method to deploy a moving body 100 such as a mobile robot in an area where people do not access directly because of a lot of hazardous factors such as radioactive area and remotely control the moving body 100 to accomplish the intended task.

During performing the task, there may occur a situation where the moving body 100 cannot be remotely controlled any more. Moreover, leaving the moving body 100 alone continuously in the hazardous area may cause a secondary accident. To prevent the secondary accident, personnel have frequently entered into the hazard area and move the moving body 100 to the outside, which may cause safety accident in a state which does not enough to remove the hazardous factors. Alternatively, the moving body 100 may be retrieved to the outside by pulling a cable to supply control and power to the moving body 100, which may cause the tension of the cable to result in the damage of inside metal lines or a collision of the moving body 100 to peripheral substances to result in a damage of the moving body 100 in the process of pulling the cable.

In accordance with an embodiment of the present invention of the moving body returning method, in the case where the remote controlling apparatus and the moving body are connected by wire, the moving body 100 may be returned to its initial starting location by photographing a portion of a cable of the moving body 100 and setting the direction for which the portion of the cable is headed as a moving direction to move the moving body 100. In the case where the remote controlling apparatus and the moving body are wirelessly connected, the moving body 100 may be returned to its initial starting location by sequentially storing IDs of APs to which the moving body 100 accessed while it is moving and detecting an RSSI of the AP to which the moving body 100 accesses at current location. Accordingly, the moving body returning method in accordance with the embodiment may implement a returning method of the moving body 100 to an original point by utilizing a moving body's own power even if the moving body 100 is placed in a situation where it cannot be controlled.

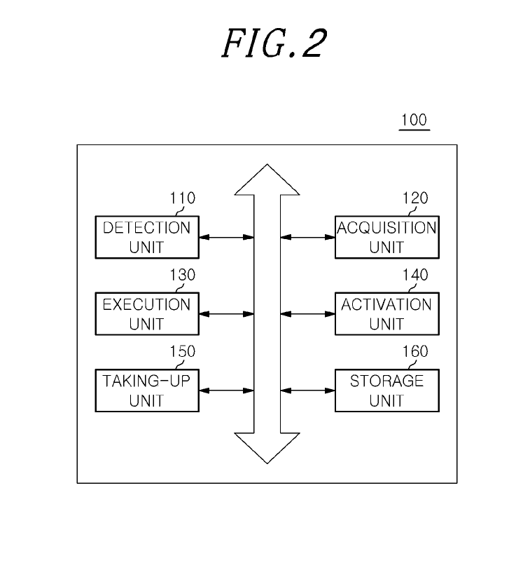

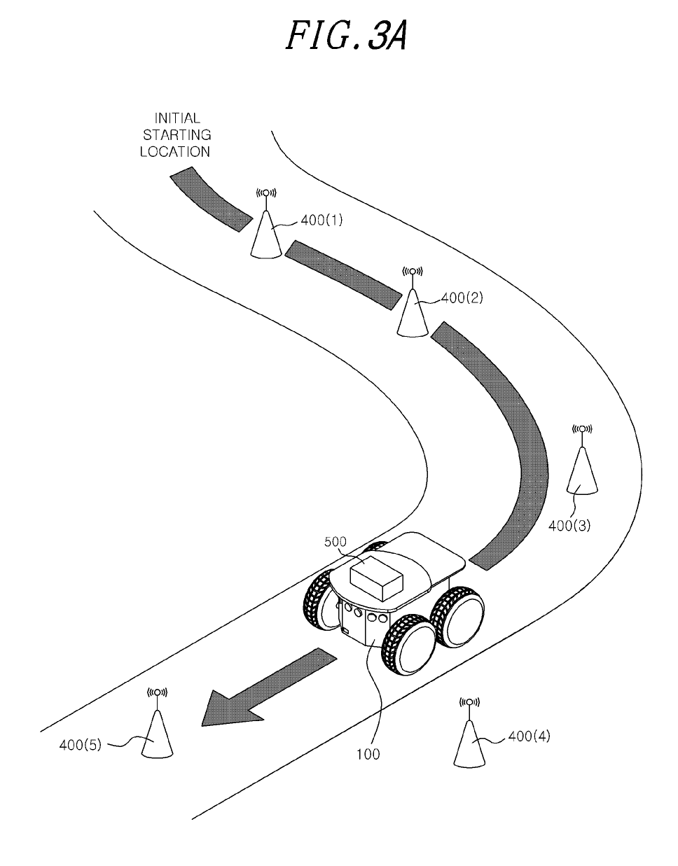

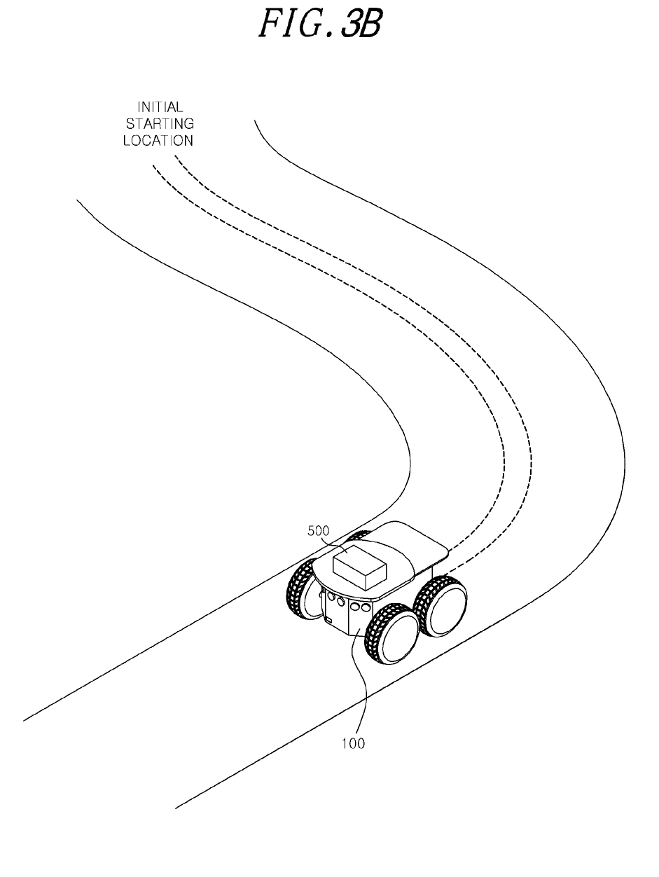

FIG. 2 is a block diagram of the moving body returning apparatus 500 shown in FIG. 1; FIG. 3A is an exemplary diagram illustrating an embodiment wherein the moving body returning apparatus 500 shown in FIG. 1 controls a moving body 100 wirelessly; and FIG. 3B is an exemplary diagram illustrating an embodiment wherein the moving body returning apparatus 500 shown in FIG. 1 controls a moving body 100 by wire.

Referring to FIG. 2, the moving body returning apparatus 500 in accordance with an embodiment of the present invention includes a detection unit 110, an acquisition unit 120, an executing unit 130, an activation unit 140, a taking-up unit 150, and a storage unit 160.

The detection unit 110 detects the remote control signal received from the remote controlling apparatus 300. Here, the detection unit 110 determines whether the remote control signal received from the remote controlling apparatus 300 is carried out in the moving body 100.

The acquisition unit 120 acquires data relevant to a reference direction for returning the moving body 100 when the remote control signal is longer feasible to control the moving body 100. What the remote control signal is no longer feasible to control the moving body 100 may refer to a situation where the control signal itself is disconnected or delayed such that it cannot be interpreted by the moving body 100 or a situation where the remote control signal is normal but it cannot be interpreted and executed owing to software problem in the moving body 100.

In addition, the data relevant to the reference direction for returning may be data that photographs a portion of the cable (not shown) of the moving body 100, in the case where the communication between the remote controlling apparatus 300 and the moving body returning apparatus 500 is a wired communication. Meanwhile, the data relevant to the reference direction for returning may be a received signal strength indication (RSSI) of one or more APs 400 that are detected by the moving body 100, in the case where the communication between the remote controlling apparatus 300 and the moving body returning apparatus 500 is a wireless communication.

For the former case, the direction of the cable may match the reference direction which is a returning path direction because the cable of the moving body 100 is generally placed along a path on which the moving body 100 has been moved. Therefore, the acquisition unit 120 photographs the cable using a photographing device (not shown). If the scenes other than the cable are photographed, the direction which is opposite to the direction to which the moving body 100 photographs will become the direction to which the moving body 100 needs to go to return. Here, the photographing device may be a CCD (Charge Coupled Device), CMOS (Complementary Metal-Oxide Semiconductor) or any other light receiving device. Further, when the moving body 100 returns, the moving body 100 is controlled to move in backward movement because the cable may be tangled if the moving body 100 turns around and moves forward if not backward movement. Thus, in the case where the communication between the remote controlling apparatus 300 and the moving body returning apparatus 500 is the wired communication, the taking-up unit 150 serves to automatically wind up the cable. In other words, the taking-up unit 150 automatically wind up the cable in order to prevent the cable from being hanged loosely or entangled during the moving body 100 is controlled to return.

Meanwhile, for the latter case, because the moving body 100 is wirelessly connected with the remote controlling apparatus 300, the moving body 100 stores a trace of one or more APs 400 to which it accessed while moving. That is, one or more APs 400 to relay the communication may exist in a wireless environment, and the moving body 100 may store the IDs of the APs 400 to which it accessed while moving. Accordingly, the moving body returning apparatus 500 in accordance with an embodiment of the present invention utilizes the RSSI of one or more APs 400 by analyzing the RSSI as the reference direction to which the moving body 100 returns. For example, as shown in FIG. 3A, it is assumed that the moving body 100 had accessed the APs 400 in order of ID No. 1-2-3-4 and accesses the AP 400 having ID No. 4 at present. If the RSSI of the AP 400 having ID No. 4 does not have a peak point, it indicates that the moving body 100 is located at some distance from the AP 400 having ID No. 4. Accordingly, the moving body 100 may move to the direction to which the RSSI of the AP 400 having ID No. 4 becomes the peak point. The moving body returning apparatus 500 then measures the RSSI from the AP 400 having ID No. 3 and allows the moving body 100 to move to the directing to which the RSSI increases. In this manner, the moving body 100 can return to an initial starting location using the RSSI of the AP 400 in order of ID 4-3-2-1.

The execution unit 130 executes a returning control to come back to the initial starting location using the data relevant to the reference direction. In the case where the communication between the remote controlling apparatus 300 and the moving body returning apparatus 500 is the wired communication, the direction of the cable is set as the reference direction to move the moving body 100 using the data relevant to the reference direction, which photographs the cable, and the moving body 100 is controlled to move along the reference direction.

The storage unit 160 serves to store the IDs of one or more APs 400 in sequence to which the moving body 100 accessed from the starting location in the case where the communication between the remote controlling apparatus 300 and the moving body returning apparatus 500 is the wireless communication. Accordingly, the execution unit 130 identifies the ID of the AP 400 to which the moving body 100 accesses at a current location and checks the RSSI of the accessed AP 400. When the ID of the accessed AP 400 matches an ID that is stored and the RSSI of the accessed AP 400 is below a preset RSSI, the execution unit 130 moves the moving body 100 to the direction to which the RSSI increases. Further, when the ID of the accessed AP 400 matches an ID that is stored and the RSSI of the accessed AP 400 is above a preset RSSI, the execution unit 130 moves the moving body 100 to the direction to which a previous AP 400 is detected based on the IDs of the APs the AP 400 that are stored sequentially.

The activation unit 140 stops the returning control when the moving body 100 comes back to the initial starting location and activates the remote control signal of the remote controlling apparatus 300. However, if the moving body 100 does not come back to the initial starting location, the activation unit 140 returns the returning control to the operation to detect the remote control signal from the remote controlling apparatus 300 so that the loop can be repeated.

The embodiment having the aforementioned configuration of the present invention will be separately explained with reference to FIG. 3A and FIG. 3B.

FIG. 3A is an exemplary diagram illustrating an embodiment wherein the remote controlling apparatus controls the moving body 100 wirelessly. Referring to FIG. 3A, for a wireless control mode, the taking-up unit 150 is not required in the moving body returning apparatus 500. One or more APs 400 to relay the wireless communication exist in the wireless environment and hand-over between the Aps may occur as the moving body 100 travels. Accordingly, the AP 400 that is currently connected to the moving body 100 by the remote controlling apparatus 300 may be changed. In this case, the storage unit 160 stores the IDs of the APs 400 to which the moving body 100 accessed. In accordance with an embodiment of the present invention, the RSSI relevant to the ID of the AP 400 may be used in the determination of the reference direction for returning by analyzing the RSSI. This is because the RSSI of the APs 400 can be detected although the moving body 100 breaks down and is disable to wireless communicate. Thus, the moving body returning apparatus 500 can detect the RSSI of the APs 400 through the acquisition unit 120, and the storage unit 160 can store the IDs of the APs the AP 400 to which the moving body 100 accessed. For example, it is assumed that the AP 400 having ID No. 3 is located in the vicinity of the moving body 100 at present but the AP 400 having ID No. 2 had been accessed by the moving body 100. In this case, the reference direction to return the moving body 100 becomes the direction to which wireless signals are detected from the AP 400 having ID No. 2. If the RSSI of the AP 400 having ID No. 2 reaches a peak during the moving body 100 travels, the moving body 100 continues to move along the reference direction to which wireless signals are detected from the AP 400 having ID No. 1.

FIG. 3B is an exemplary diagram illustrating an embodiment wherein the remote controlling apparatus controls the moving body 100 by wire. Referring to FIG. 3B, for a wired control mode, the acquisition unit 120 of the moving body returning apparatus 500 which is located near the joint portion of the cable attached to the rear of the moving body 100 acquires information about the rear space of the moving body 100. For example, in the case where an image sensor is mounted in the moving body 100, it takes a picture the rear space from the portion of the cable of the moving body 100 to a certain distance. Here, the cable may be tightly pulled back with an amount of tension. Accordingly, the moving body returning apparatus 500 can determine the reference direction to return the moving body 100 based on the direction to which the cable is placed, which is acquired by the acquisition unit 120. After determining the reference direction, the execution unit 130 may control the moving body 100 to move along the reference direction that is determined earlier. At this time, the moving body 100 may be moved backward in order to prevent the cable from being twisted or tangled when the moving body 100 changes its direction and goes forward. In addition, the taking-up unit 150 is responsible to take up the cable back so as not to hang loosely as the moving body 100 moves. The acquisition unit 120 then determines whether the moving body 100 returns to the initial starting location based on the data relevant to the rear space of the moving body 100. If the moving body 100 does not reach the initial starting location, the moving body returning apparatus 500 may determine whether the moving body 100 is returned to a state where it can be controlled remotely. If it becomes possible to remotely control the moving body 100 due to the recovery of the communication or the restoration of the moving body 100, the feedback device 100 transfers the right to control to the remote controlling apparatus 300, and otherwise, continues the returning control to the starting point by repeating the loop.

The two functions described above may be implemented by software algorithm, and the moving body returning apparatus 500 may be manufactured in a small volume inclusive of sensors in the case where it is embedded in the moving body 100. The manufactured moving body returning apparatus 500 may be mounted in a position where it can be protected from external impact. Accordingly, even if an external impact is applied to the moving body 100 or the moving body 100 breaks down, the moving body returning apparatus 500 may be enabled when the safe return is required. Moreover, in situations where the power source of the moving body 100 is not exhausted and/or driving motors are not out of order, it is possible to move the moving body 100 from the hazardous area by utilizing actively driving function of the moving body 100 itself.

Therefore, the moving body returning method in accordance with an embodiment of the present invention enables the moving body 100 to return a location from which the moving body 100 is deployed, even if the by-wire remote control is impossible, by recognizing the location of the cable drawn from the moving body 100 through the use of the image sensor that is mounted in the moving body 100 and guiding the moving body 100 to follow the direction from which the cable is drawn. In addition, even if the wireless remote control is impossible, a method to safely return the moving body 100 from hazard areas can be provided by reversely tracing the APs to which the moving body 100 had accessed while moving and setting the reference direction using the RSSI of the Aps so as to move along the reference direction.

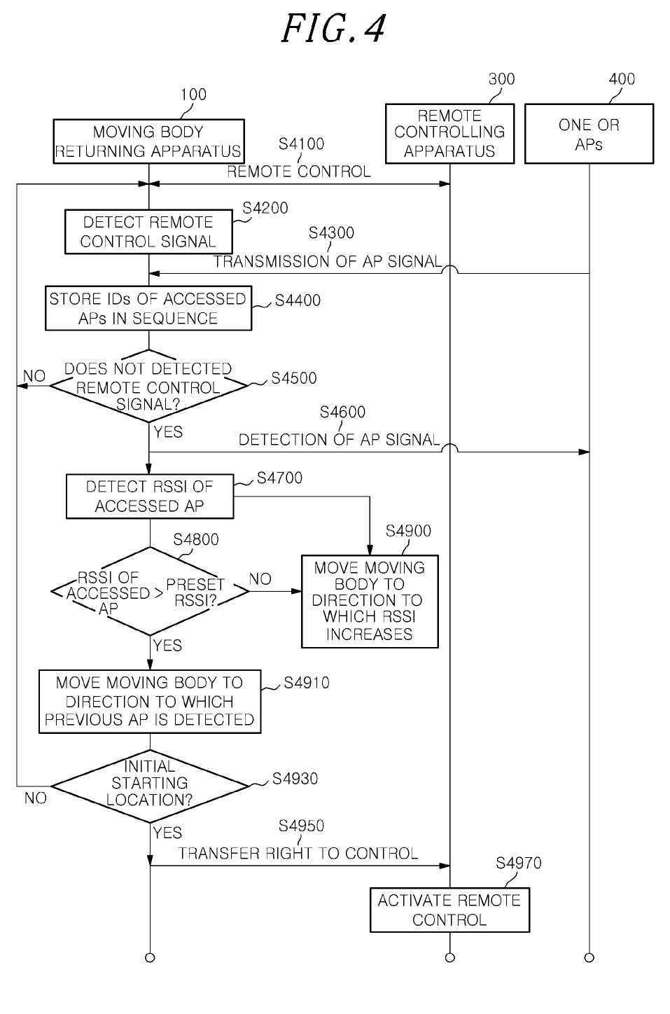

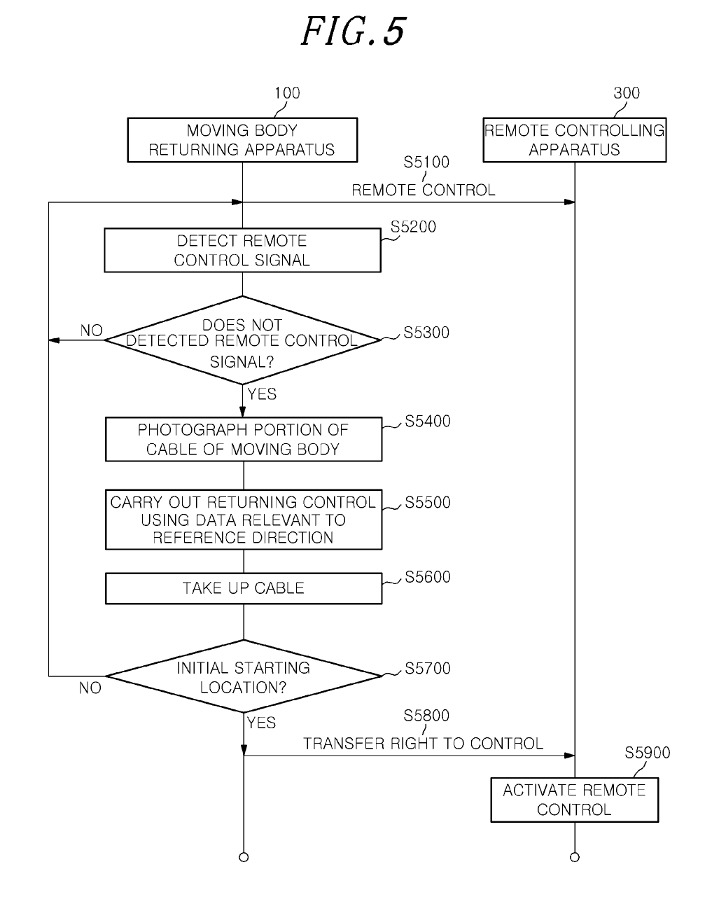

FIG. 4 is a sequential diagram showing a process of transmitting and receiving data between the respective components of the system for returning a moving body 100 shown in FIG. 1 when the system is wirelessly connected in accordance with an embodiment of the present invention; and FIG. 5 is a sequential diagram illustrating a process of transmitting and receiving data between the respective components comprised of the system for returning a moving body 100 shown in FIG. 1 when the system is connected by wire in accordance with another embodiment of the present invention. Hereinafter, the description on examples of the process of transmitting and receiving signals will be made with reference to FIGS. 4 and 5. However, the present invention is not construed to be limited to those embodiments, and it will be appreciated to those skilled in the art that the process of transmitting and receiving data as shown in FIGS. 4 and 5 may be modified in accordance with the different embodiments as set forth above.

Referring to FIG. 4, the remote control signal is received from the remote controlling apparatus 300 in block S4100, and the moving body returning apparatus 500 detects the remote control signal in block S4200.

When the moving body returning apparatus 500 determines that the remote control signal is normally executed in the moving body 100, it receives an AP signal from one or more APs 400 and sequentially stores the ID of the APs 400 to which the moving body returning apparatus 500 accessed in block S4400.

After that, the moving body returning apparatus 500 checks whether the remote control signal is not detected in block S4500. When it is checked that the moving body 100 returning apparatus 100 does not detected or the moving body 100 does not run in accordance with the remote control signal, the moving body returning apparatus 500 detects the signal from an AP 400 to which it access in block S4600.

In block S4800, the moving body returning apparatus 500 determines whether the RSSI of the AP 400 is above a preset RSSI. When the RSSI of the AP 400 is not above the preset RSSI, the moving body returning apparatus 500 moves the moving body 100 to the direction to which the RSSI increases in block S4900. However, the RSSI of the AP 400 is above a preset RSSI, the moving body returning apparatus 500 moves the moving body 100 to the direction to which a previous AP 400 is detected in block S4910.

The moving body returning apparatus 500 checks whether where the moving body 100 is located currently is the initial starting location in block S4930. When it is checked that the moving body 100 returns to the initial starting location, the moving body returning apparatus 500 passes the right to control to the remote controlling apparatus 300 in block S4950 and activates the remote control of the remote controlling apparatus 300 in block S4970. However, when it is checked that the moving body 100 does not return to the initial starting location, the process returns to block S4100 or 54700 to repeat the loop until the moving body 100 arrives at the initial starting location.

Referring to FIG. 5, the remote control signal is received from the remote controlling apparatus 300 in block S5100, and the moving body returning apparatus 500 detects the remote control signal in block S5200.

When the moving body returning apparatus 500 determines that the remote control signal is not detected or does not normally executed in the moving body 100 in block S5300, it photographs the portion of the cable in block S5400. Thereafter, the moving body returning apparatus 500 carries out the returning control using data relevant to the reference direction in block S5500 and takes up the cable in block S5600.

The moving body returning apparatus 500 checks whether where the moving body 100 is located currently is the initial starting location in block S5700. When it is checked that the moving body 100 returns to the initial starting location, the moving body returning apparatus 500 transfers the right to control to the remote controlling apparatus 300 in block S5800 and activates the remote control of the remote controlling apparatus 300 in block S5900.

Further details of the moving body returning method of FIGS. 4 and 5 will not be described below since they are similar or identical to the description made through FIGS. 1 to 3 and can be easily inferred from the description.

The order of the operations described in blocks S4100 to S4970 and S5100 to S5900 is merely as an example and not limited thereto. In other words, the order of the operations described in blocks S4100 to S4970 and S5100 to S5900 may be mutually exchanged, and some of these operations may be simultaneously executed or removed.

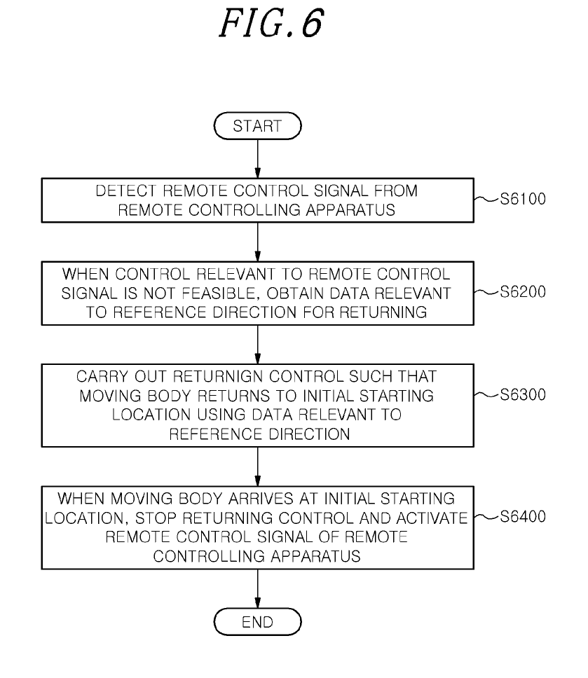

FIG. 6 is a flow diagram explaining a moving body returning method in accordance with an embodiment of the present invention.

Referring to FIG. 6, the moving body returning apparatus detects the remote control signal from the remote controlling apparatus in block S6100.

Next, when it is detected that the control relevant to the remote control signal is not feasible, the moving body returning apparatus obtains data relevant to the reference direction for returning in block S6200.

The moving body returning apparatus then carries out the returning control such that the moving body can be returned to the initial starting location using the data relevant to the reference direction in block S6300.

When the moving body arrives at the initial starting location, finally, the moving body returning apparatus stops the returning control and activates the remote control signal of the remote controlling apparatus in block S6400.

Further details of the moving body returning method shown in FIG. 6 will not be described below since they are similar or identical to the description made through FIGS. 1 to 5 and can be easily inferred from the description.

The object tracking method described in FIG. 6 may be implemented in the form of recording media including instructions executable by a computer, such as applications or program modules that are executed by a computer. The computer readable media may be any available media that can be accessed by a computer and may include volatile and nonvolatile media, and removable and non-removable media. Further, the computer readable media may include any computer storage media and communication media. The computer storage media may include any volatile and nonvolatile media and removable and non-removable storage media that are implemented in any methods or technologies for the storage of information such as data and computer-readable instructions, data structures, program modules, or other data. The communication media may include a transport mechanism or any information delivery media for transmitting computer readable instructions, data structures, program modules or other data of modulated data signal such as carrier waves.

Description of the present invention as described above are intended for illustrative purposes, and it will be understood to those having ordinary skill in the art that this invention can be easily modified into other specific forms without changing the technical idea and the essential characteristics of the present invention. Accordingly, it should be understood that the embodiments described above are exemplary in all respects and not limited thereto. For example, respective components described to be one body may be implemented separately from one another, and likewise components described separately from one another may be implemented in an integrated type.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A method for returning a moving body in a moving body returning apparatus, the method comprising:
detecting a remote control signal from a remote controlling apparatus;
acquiring data corresponding to a reference direction to return the moving body when the control relevant to the remote control signal is not feasible;
carrying out a returning control to return the moving body to an initial starting location using the data relevant to the reference direction; and
stopping the returning control and activating the remote control signal of the remote controlling apparatus when the moving body arrives at the initial starting location.

2. The method of claim 1, wherein the data relevant to a reference direction is data that photographs a portion of cable of the moving body, in the case where the communication between the remote controlling apparatus and the moving body is a wired communication.

3. The method of claim 1, wherein the data relevant to a reference direction is an RSSI (Received Signal Strength Indication) of one or more APs (Access Points) to which the moving body accesses, in the case where the communication between the remote controlling apparatus and the moving body is a wireless communication.

4. The method of claim 1, wherein said carrying out a returning control comprises:
taking-up a cable of the moving body, in the case where the communication between the remote controlling apparatus and the moving body is a wired communication.

5. The method of claim 1, wherein said carrying out a returning control comprises:
setting the direction of a portion of a cable of the moving body as the reference direction to move the moving body using the data relevant to the reference direction that photographs the portion of the cable; and
controlling the moving body to move along the reference direction.

6. The method of claim 1, further comprising:
sequentially storing IDs of one or more APs that are detected by the moving body from an initial starting location of the moving body.

7. The method of claim 6, wherein said carrying out a returning control comprises:
detecting an ID of an AP to which the moving body accesses at current location and an RSSI of the accessed AP;
when the ID of the accessed AP matches the ID that is stored and the RSSI of the accessed AP is below a preset RSSI, controlling the moving body to move along the direction to which the RSSI of the accessed AP increases; and
when the ID of the accessed AP matches the ID that is stored and the RSSI of the accessed AP is above a preset RSSI, controlling the moving body to move along the direction to which a previous AP is detected based on the IDs of one or more APs that are sequentially stored.

8. The method of claim 1, further comprising:
returning to said detecting the remote control signal to repeat a loop, when the moving body does not reach the initial starting location.

9. An apparatus for returning a moving body comprising:
a detection unit configured to detect a remote control signal from a remote controlling apparatus;
an acquisition unit configured to acquire data relevant to a reference direction to return the moving body when the control relevant to the remote control signal is not feasible;
an execution unit configured to carry out a returning control to return the moving body to an initial starting location using the data relevant to the reference direction; and
an activation unit configured to stop the returning control and activating the remote control signal of the remote controlling apparatus when the moving body arrives at the initial starting location.

10. The apparatus of claim 9, wherein the execution unit is configured to:
set the direction of a portion of a cable of the moving body as the reference direction to move the moving body using the data relevant to the reference direction that photographs the portion of the cable, in the case where the communication between the remote controlling apparatus and the moving body is a wired communication; and
control the moving body to move along the reference direction.

11. The apparatus of claim 9, further comprising:
a storage unit configured to sequentially store IDs of one or more APs (Access Points) that are detected by the moving body from an initial starting location of the moving body, in the case where the communication between the remote controlling apparatus and the moving body is a wireless communication.

12. The apparatus of claim 11, wherein the execution unit is configured to:
detect an ID of an AP to which the moving body accesses at current location and an RSSI of the accessed AP;
when the ID of the accessed AP matches an ID that is stored and the RSSI of the accessed AP is below a preset RSSI, control the moving body to move along the direction to which the RSSI of the accessed AP increases; and
when the ID of the accessed AP matches an ID that is stored and the RSSI of the accessed AP is above a preset RSSI, control the moving body to move along the direction to which a previous AP is detected based on the IDs of one or more APs that are sequentially stored.
